(19) United States
(12) Patent Application Publication
(10) Pub. No.: US 2008/0078645 A1
(43) Pub. Date: Apr. 3, 2008

(54) FIXED CLUTCH FOR A TURBOCHARGER

(76) Inventors: Mark S. Frederick, Canaan, NY (US); Doug Guerineau, Troy, NY (US); Norbert B. Abraham, Schenectady, NY (US); Eric Premo, Troy, NY (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/536,800

(22) Filed: Sep. 29, 2006

(51) Int. Cl. F16D 11/00

(52) U.S. Cl. 192/30 R

(57) ABSTRACT

A clutch assembly permanently fixed between a rotary input member and a rotary output member to produce a driving connection between the members, the clutch assembly comprising a plurality of elements wherein every element of the clutch assembly is permanently fixed together so that the clutch assembly does not rotate.

### FIELD OF INVENTION

This invention relates generally to turbochargers, and, more specifically, to a clutch used in turbochargers for locomotives.

### BACKGROUND OF THE INVENTION

Conventionally, turbochargers are operably connected to an internal combustion engine in which exhaust gas from the engine is utilized to increase the pressure of air above ambient to the engine. In a typical turbocharger, a turbine is driven by engine exhaust gas. The turbine then drives a compressor that draws in ambient air and increases the pressure of intake air provided to the engine. This permits more fuel to be burned in the cylinder and, therefore, the expanding products of combustion will exert more force on the piston during each power stroke.

The main advantage of a turbocharger is that it increases the power output of a diesel engine. However, the addition of the turbocharger to the engine also increases the complexity of the operation of the engine and its control and maintenance. Typically, the turbocharger includes a shaft, a driving turbine or expander attached at one end of the shaft, and a compressor attached to the other end of the shaft. The expander is attached to the engine to receive exhaust gases from the engine and the compressor is attached to an air intake manifold of the engine. During operation, the expander receives exhaust gas which causes the shaft to rotate which, in turn, causes the compressor to rotate and supply air to the air intake manifold of the engine at an increased pressure, i.e., at a pressure greater than ambient air pressure.

An element used within the turbocharger is a clutch. Clutches are considered load-transmitting mechanisms and are susceptible to wear during the transition period when the clutch is engaging and disengaging, in which the input and output members are being coupled and uncoupled.

### BRIEF DESCRIPTION OF THE INVENTION

This invention is directed towards a clutch used in turbochargers for locomotives. Towards this end a clutch assembly permanently fixed between a rotary input member and a rotary output member is disclosed. The clutch assembly produces a driving connection between the members. The clutch assembly comprises a plurality of elements wherein every element of the clutch assembly is permanently fixed together so that the clutch assembly does not rotate.

In another exemplary embodiment a clutch assembly permanently fixed between a rotary input member and a rotary output member so as to produce a driving connection between the members is disclosed. The clutch assembly comprises a clutch support with an inner cavity formed therein, and a turbine bearing fixed within the inner cavity of the clutch support. A ring gear plate having an annular configuration with a back side of the ring gear plate fixed to an end of the clutch support and a front side is also disclosed. Also disclosed is a ring gear fixed within the front side of the ring gear plate. No independently moving parts are part of the clutch and the clutch support, turbine bearing, ring gear plate, and ring gear are permanently fixed together so that the clutch assembly does not rotate.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a cross-sectional view of a prior art clutch taken along 1-1 of FIG. 3;

FIG. 2 depicts an exemplary location of a clutch location inside a turbocharger;

FIG. 3 depicts a front view of the prior art;

FIG. 4 depicts a cross-section view of the present invention clutch taken along 4-4 of FIG. 5; and

FIG. 5 depicts a front view of the present invention clutch.

### DETAILED DESCRIPTION OF THE INVENTION

With reference to the figures, exemplary embodiments of the invention will now be described. Though this invention is described with respect to a locomotive engine system, the present invention is not intended to be limited to locomotive engine systems. Those skilled in the art will readily recognize that the present invention is applicable to other engine systems that utilize a turbocharger.

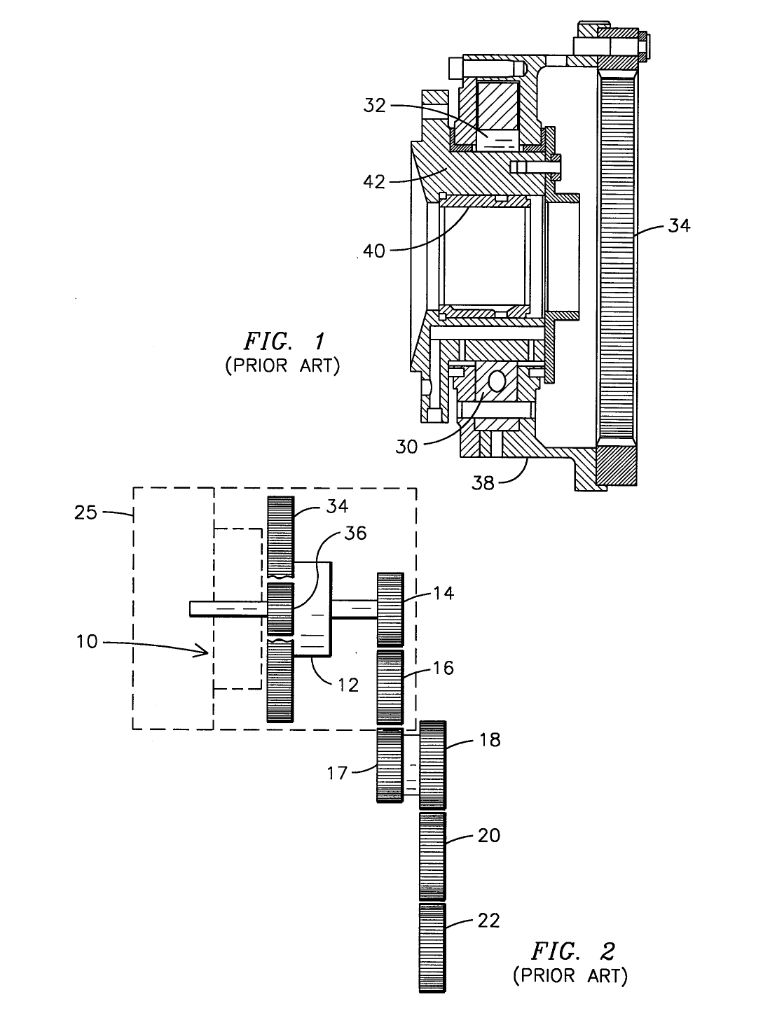

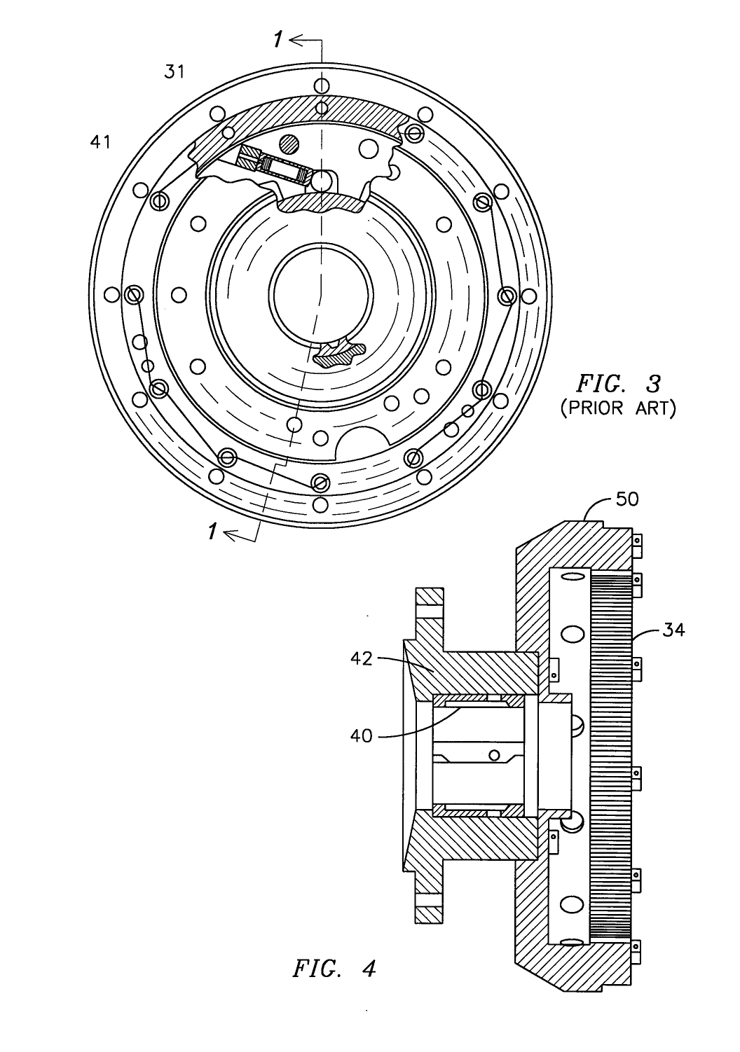

FIG. 1 depicts a cross-sectional view of a prior art clutch and FIG. 2 depicts an exemplary location of a clutch location inside a turbocharger. FIG. 3 depicts a front view of the prior art clutch illustrating elements that are no longer required in the present invention. The prior art clutch 10 engages and disengages from a planetary gear set 12 depending on the speed at which the gears 14, 16, 17, 18, 20, 22 are turned. Such a clutch 10 is currently used in the Assignee's EMD engine. An example of such a clutch is the Assignee's EMD-compatible 645 turbocharger. FIGS. 1 & 3 are exemplary views of the 645 turbocharger.

In operation, at lower engine speeds and loads, the turbocharger 25, wherein the clutch 10, ring gear 34, sun gear 36, planetary gear set 12, carrier drive gear 14, turbo idler gear 16, and turbo drive gear 17 reside inside the turbocharger 25, must be mechanically driven since the exhaust gases do not contain enough energy to drive the turbocharger 25. However, at higher speeds, sufficient energy is provided to drive the turbocharger 25, thus requiring the clutch 10 to disengage the turbocharger rotor from the gear train 14, 16, 17, 18, 20, 22 of the locomotive. This allows the turbocharger 25 to respond to the input provided by the exhaust gases. A clutch designed for this purpose includes an annular-shaped camplate 30 that has a number of slots formed in its outer periphery. The base of each slot defines a ramp that is in rolling contact with a cylindrical roller 32.

Thus, prior to having enough power to disengage, the ring gear 34 and the camplate 30, which are always locked together, are locked to the clutch support 42. When the turbocharger 25 is operating at a high enough speed, the increased torque from the sun gear 36 feeds through planetary gears 12 to rotate the ring gear 34 and camplate 30 in an unlocking direction. Also further disclosed in FIG. 1, a clutch housing 38 and turbine bearing 40 are provided. The clutch housing 38 now rotates around the clutch support 42 at a speed that equals the difference between the engine gear train speed and the turbine wheel revolutions per minute (RPM). During this overrunning condition, the clutch rollers 32 move to a wide end of the wedge-shaped pockets formed by the camplate ramps.

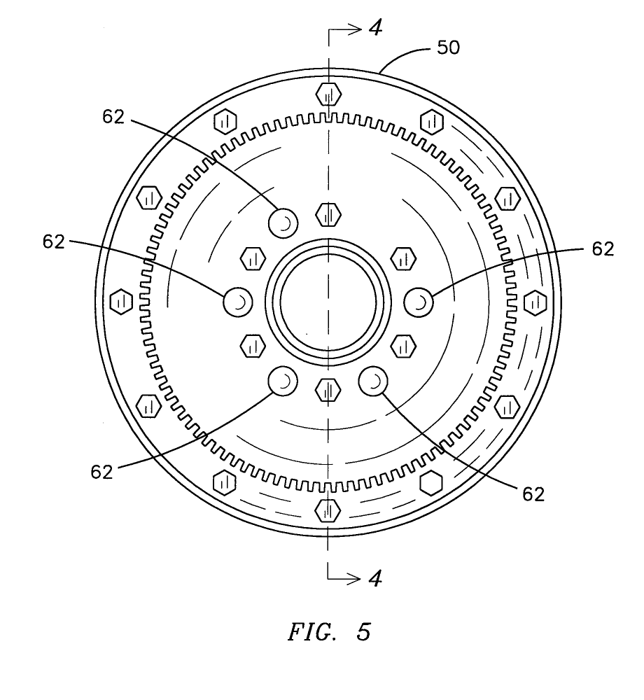

FIG. 4 depicts a cross-section view of the present invention clutch taken along 4-4 of FIG. 5. Comparing FIG. 4 to FIG. 3, and FIG. 4 to FIG. 1, the rollers 32, clutch camplate 30, springs 41 and cups 31 are not used in the present invention. All other parts are fixed together. This embodiment reduces the number of movable parts that results in both a cost savings in manufacturing, repair, and replacement. A replacement cost is realized because by having all elements fixed together, a reduction in component wear is achieved. Similar reasoning is also a basis for realizing savings in manufacturing and repair cost.

In an exemplary embodiment many prior art components are still used in the present invention. For example, the clutch support 42, ring gear 34, and turbine bearing 40 are the same parts as used in the prior art. A key element added to the present invention is a ring gear plate 50. The ring gear plate 50 surrounds the ring gear 34 and connects to the clutch support 42.

FIG. 5 depicts a front view of the present invention clutch. As illustrated, connectors, such as but not limited to dowel pins 62, are provided between the clutch support (not shown) and ring gear plate 50. In an exemplary embodiment, five dowel pins are provided. The dowel pins 62 provide improved torque-carrying capability as they carry the torque load applied through the planetary gear train 12.

The fixed clutch design of the present invention effectively converts the turbocharger 25 into a supercharger since the ring gear 34 does not rotate. As those skilled in the art will readily recognize, both a turbocharger 25 and a supercharger are used to compress and so increase the mass of air that is available for combustion in an engine and boost the power output. The supercharger is typically a positive displacement mechanically driven unit with intermeshing rotors while the turbocharger has an exhaust driven turbine wheel connected to a compressor wheel in the intake air ducting. Though a supercharger may use more power directly from an engine, when operating at full capacity, the present invention provides a greater boost to the power output of the engine over prior art turbochargers in certain applications. At lower revolutions per minute (RPMs) a supercharger provides greater boost, but at higher RPMs, where engine exhaust gas can be better utilized, this is not necessarily true.

Furthermore, the present invention provides better reliability for switcher applications. A switch is usually a lower-powered locomotive used in railroad yards to move boxcars around. Sometimes they are specialty locomotives, but often times they are older de-rated locomotives that have been removed from road service. In switch applications, the turbocharger 25 usually will not come on and off the clutch.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

What is claimed is:

1. A clutch assembly permanently fixed between a rotary input member and a rotary output member to produce a driving connection between the members, the clutch assembly comprising a plurality of elements wherein every element of the clutch assembly is permanently fixed together so that the clutch assembly does not rotate.

2. The clutch assembly of claim 1 wherein the plurality of elements comprise a clutch support with an inner cavity formed therein, a turbine bearing fixed within the inner cavity of the clutch support, a ring gear plate having an annular configuration with a back side of the ring gear plate being fixed to an end of the clutch support, and a ring gear fixed within the ring gear plate.

3. The clutch assembly of claim 2 wherein the plurality of elements further comprises a pin disposed therethrough the clutch support and ring gear plate so as to fix the clutch support and the ring gear plate together.

4. The clutch assembly of claim 3 wherein the pin provides an improved torque-carrying capability.

5. The clutch assembly of claim 2 wherein a plurality of pins are disposed therethrough the clutch support and ring gear plate so as to fix the clutch support and the ring gear plate together.

6. The clutch assembly of claim 5 wherein the pins provide an improved torque-carrying capability.

7. The clutch assembly of claim 5 where the plurality of pins comprises five pins.

8. A clutch assembly permanently fixed between a rotary input member and a rotary output member so as to produce a driving connection between the members, the clutch assembly comprising:
a. a clutch support with an inner cavity formed therein;
b. a turbine bearing fixed within the inner cavity of the clutch support;
c. a ring gear plate having an annular configuration with a back side of the ring gear plate fixed to an end of the clutch support and a front side;
d. a ring gear fixed within the front side of the ring gear plate;
e. wherein no independently moving parts are part of the clutch; and
f. wherein the clutch support, turbine bearing, ring gear plate, and ring gear are permanently fixed together so that no rotation occurs.

9. The clutch assembly of claim 8 further comprises a pin disposed therethrough the clutch support and ring gear plate so as to fix the clutch support and the ring gear plate together.

10. The clutch assembly of claim 9 wherein the pin provides an improved torque-carrying capability.

11. The clutch assembly of claim 8 further comprises a plurality of pins disposed therethrough the clutch support and ring gear plate so as to fix the clutch support and the ring gear plate together.

12. The clutch assembly of claim 11 wherein the pins provide an improved torque-carrying capability.

13. The clutch assembly of claim 11 where the plurality of pins comprises five pins.
